(19) United States
(12) Patent Application Publication
(10) Pub. No.: US 2013/0277903 A1
(43) Pub. Date: Oct. 24, 2013

(54) Precision Vise Jaw Plates

(71) Applicants: Scott J. Gray, Brooksville, FL (US); David D. Emmendorfer, Clearwater, FL (US)

(72) Inventors: Scott J. Gray, Brooksville, FL (US); David D. Emmendorfer, Clearwater, FL (US)

(73) Assignee: COBRA CUT LLC, Clearwater, FL (US)

(21) Appl. No.: 13/455,032

(22) Filed: Apr. 24, 2012

(51) Int. Cl. B25B 1/24; B25B 1/20

(52) U.S. Cl. 269/282; 269/280

(57) ABSTRACT

A vise jaw plate includes a plurality of equally sized holes arranged in a pattern and extending through a front side of the vise jaw plate which cooperate with dowel pins and work holders to position and support a work piece. Horizontally spaced mounting bores are arranged for cooperative alignment with vise jaw mounting holes to permit the attachment of the vise jaw plate to the vise jaw. The mounting bores include a first frustoconical portion, a second frustoconical portion and a straight bore portion joining the confronting narrow ends of the first and second frustoconcial portions. The mounting bores and the vise jaw mounting holes have offset center-lines that become coaxially aligned during attachment of the vise jaw plate to the vise jaw causing the vise jaw plate to become fully seated against a deck surface of the vise.

### FIELD OF THE INVENTION

The present invention relates generally to a vise for machining work pieces, and more particularly, relating to vise jaw plates for supporting and securing a work piece for machining and to the attachment of the vise jaw plates to the jaws of the vise.

### BACKGROUND OF THE INVENTION

In the machining of a work piece, it is customary to secure the work piece by a vise to hold the work piece against movement during machining. The process of securing a work piece by a vise or also referred to as the set-up of a work piece is time consuming and expensive in both labor costs and production costs. Because of this, there has been a considerable amount of attention in the field given to the development of variously configured vises and vise jaws all aimed at the purpose of reducing the time required for the set-up of a work piece. One such class of devices includes vise jaw plates having a pattern of holes formed through confronting faces thereof for the reception of dowel pins to aid in the positioning of the work piece between the vise jaws. Vise jaw plates of this class are described in U.S. Pat. Nos. 5,419,540; 6,601,839; and 6,786,123 each of which are incorporated herein in their entirety by reference.

Conventionally, in the set-up of a work piece and the securement thereof by a vise, the position of the work piece, that is the work piece's position in space, is referenced from the deck surface of the vise because the elevation of the deck surface relative to the machine tool is a known constant and the work piece must be positioned in relation to the machine tool for machining.

The precise relational aspect between the vise deck surface and the work piece can become inaccurate as a result of the bottom surface of the vise jaw plate not being fully seated against the vise deck surface. An unseated vise jaw plate may result in shifting of the vise jaw plate during machining and/or in an inaccurate work piece set-up, either of which will result in an un-usable work piece. This becomes particularly problematic with vise jaw plates of the class having utilizing dowel pins, as referenced above, because during set-up, the operator relies upon the knowledge of the precise positioning of the dowel pin holes relative to one another and also relative to the vise deck surface.

While the devices heretofore meet their respective objectives and requirements, these devices do not recognize the problems associated with a vise jaw plate that is not fully seated against the vise deck surface. Accordingly, there is a need for vise jaw plates that include the advantages provided by the class of vise jaw plates having dowel pin holes for receiving dowel pins and work holders to support a work piece between the vise jaws and which also eliminates problems and drawbacks discussed above.

### SUMMARY OF THE INVENTION

The embodiments of the present invention addresses this need by providing vise jaw plates that include a vise jaw mounting arrangement that causes the bottom surface of the vise jaw to become fully seated against a deck surface of the vise once mounted to the vise jaw.

Embodiments of the present invention also provide vise jaw plates having a pattern of holes formed through confronting faces thereof for the reception of dowel pins and work holders to aid in the precise positioning of a work piece between the vise jaws for machining.

Embodiments of the present invention further provide vise jaw plates providing reliable and repeatable work piece setup.

To achieve these and other advantages, in general, in one aspect a vise jaw plate for mounting on a vise having a vise jaw with first and second jaw plate attachment holes elevated a first distance from a deck surface of the vise is provided. The vise jaw plate has parallel front and back sides, left and right sides and a bottom side being substantially flat and orthogonal to the front and back sides. A plurality of equally sized holes are arranged in a pattern and extend through the front side and terminate at a position intermediate the front and back sides. First and second mounting bores are spaced horizontally between the left and right sides and extend through the front and the back sides and are arranged for cooperative alignment a with the first and second vise jaw mounting holes, respectively. Each of the first and second mounting bores having a first frustoconical portion extending through the front side, a second frustoconical portion extending through the back side, and a straight bore portion joining the confronting narrow ends of the first and second frustoconcial portions. Each the first and second mounting bores being elevated a second distance from the deck surface of the vise as measured when the bottom surface is rested upon the deck surface. The second distance of the first and second mounting bores is greater than the first distance of the first and second jaw plate attachment holes.

In general, in another aspect, the hole pattern being a staggered column-row matrix with the centers of holes in a common row being spaced an equal distance D1 and with the centers of holes in a common column being spaced an equal distance D2.

In general, in another aspect, one or more threaded bores extend through at least one of the left and right sides.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is an exploded perspective view of a vise, work piece holders and a vise jaw plate assembly constructed in accordance with the principles of an embodiment of the present invention;

FIG. 2 is a perspective view of a vise and an embodiment of a vise jaw plate assembly of the invention including a pair of vise plates, one attached to each vise jaw of the vise with their front sides confronting;

FIG. 3 is an elevation view of a vise jaw plate constructed in accordance with the principles of an embodiment of the present invention;

FIG. 4 is a cross-section view of the vise jaw plate of FIG. 3 taken along line 4-4, illustrating a configuration of the vise jaw plate mounting bores, each comprising frustoconical portions;

FIG. 5 is a cross-section view of the vise jaw plate of FIG. 3 taken along line 5-5, illustrating a plurality of threaded end bores extending through a side of the vise jaw plate;

FIG. 6 is a simplified, diagrammatic perspective view of a vise jaw having a pair of vise jaw plate mounting holes and a vise jaw plate of the invention exploded from the vise jaw, and illustrates the cooperative alignment between the vise jaw mounting holes of the vise jaw and the mounting bores of the vise jaw plate; and

FIG. 7 is an enlarged, partial cross-sectional and diagrammatic view of a vise jaw plate constructed in accordance with the principals of an embodiment of the invention, a vise jaw and a deck surface of a vise, and illustrates a dimensional relationship between the vise jaw mounting holes of the vise jaw and the mounting bores of the vise jaw plate with reference to the deck surface of the vise.

### DETAILED DESCRIPTION OF THE INVENTION

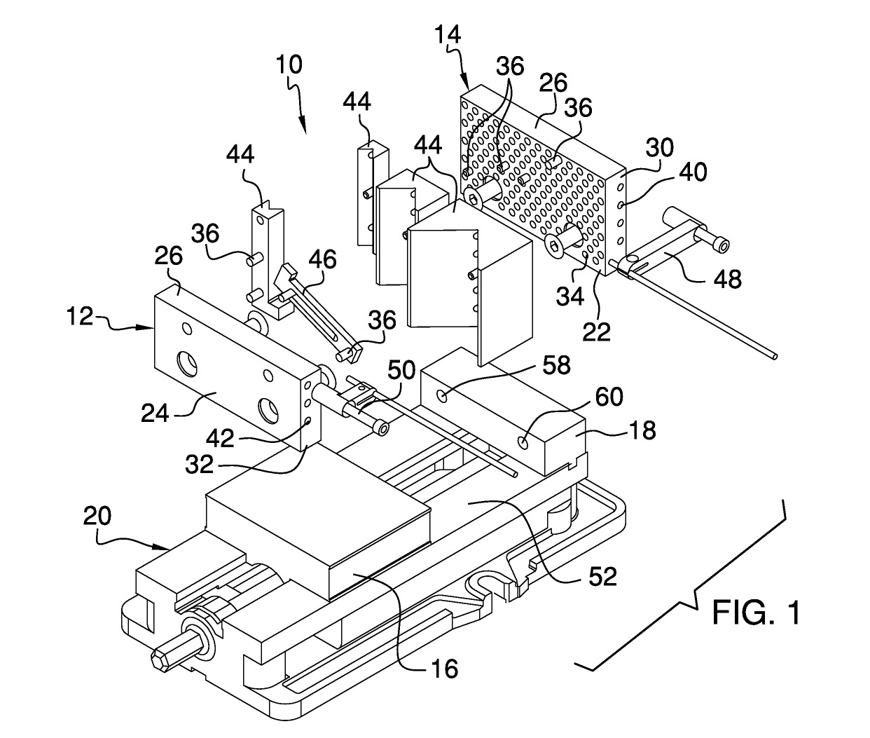

With reference to FIGS. 1 through 5, this invention provides a vise jaw plate assembly 10 for securing a work piece between the jaws of a vice for the purpose of machining the work piece. The vise jaw plate assembly 10 includes a pair of rectangular vise jaw plates 12 and 14 that are secured to opposing jaws 16 and 18, respectively, of vise 20.

Vise jaw plates 12 and 14 are similarly fashioned and include parallel front and back sides 22 and 24, parallel top and bottom sides 26 and 28 and parallel left and right sides 30 and 32. The bottom side 26 is substantially flat and orthogonal to the front and back sides 22 and 24. The front sides 22 of plates 12 and 14 include matching patterns of precision located, equally-sized holes 34 extending through the front side in a direction towards the back side 24 and normal therewith. Holes 34 do not extend fully through to the back side 24, and terminate at an intermediate position between the front and back sides 22 and 24. In an embodiment, holes 34 are patterned in a staggered column-row matrix with the centers of holes 34 existing within a common row being spaced an equal distance D1 and with the centers of holes 34 existing in a common column being spaced an equal distance D2. In an embodiment, distance D1 and distance D2 are unequal. In an embodiment, holes 34 have a diameter of 0.25-inches, distance D1 is equal to 0.50-inches and distance D2 is equal to 0.75-inches. While, alternative hole-diameter, hole-spacing and hole-patterns may be utilized, the specific staggered column-row matrix with distances D1 and D2 being unequal provide load support and setup adjustability, which is not currently present in the devices heretofore.

Preferably, holes 34 are smooth bore holes free of threading for the reception of dowel pins 36 therein for the positioning and/or alignment of various work piece holders, such as, but not limited to V-blocks 44, angle finders 46, parallels (not shown), sine-plates (not shown), etc. One or more holes 34 could be threaded if so desired. Further, while it is not illustrated, dowel pins may also be used to directly position and support a work piece.

Vise jaw plates 12 and 14 may further include a plurality of vertically spaced holes 40 extending through the left side 30 and normal thereto. Holes 40 are each threaded and are adapted to receive a threaded fastener in the mounting of work piece holders or set-up devices, for example an adjustable vise clamp 48, to the left side of the vise jaw plate 12, 14. Vise jaw plates 12 and 14 may include a plurality of vertically spaced holes 42 extending through the right side 32 and normal thereto. Like holes 40, holes 42 are threaded and are adapted to receive a threaded fastener in the mounting of work piece holders or set-up devices, for example an adjustable vise clamp 50, to the right side of the vise jaw plates 12 and 14.

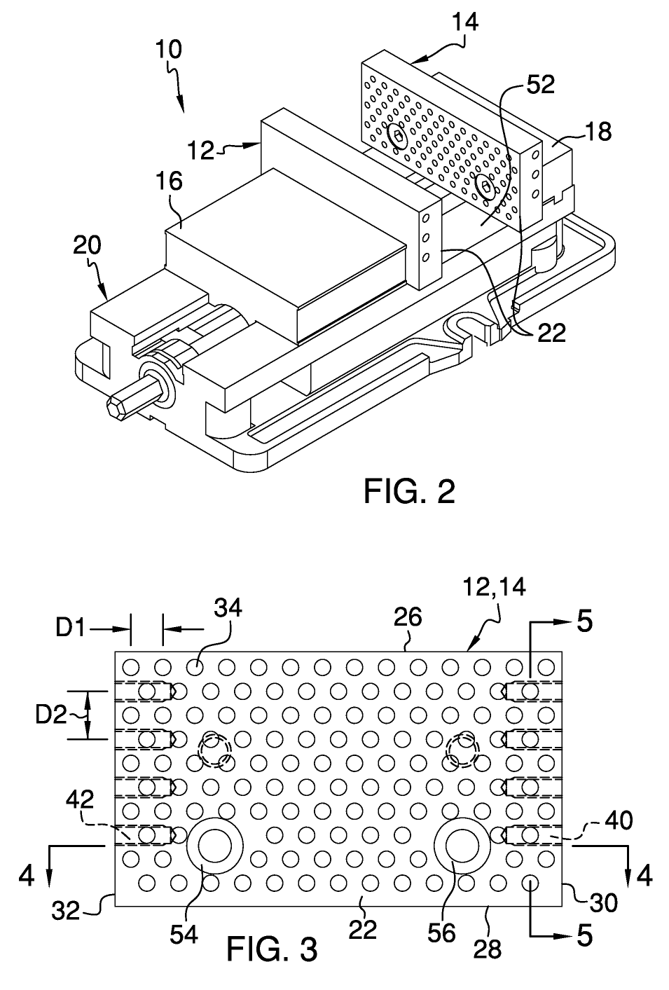

With reference to FIG. 2, vise jaw plates 12 and 14 are mounted to opposite vise jaws 16 and 18, respectively, with the front side 22 of plate 12 confronting the front side 22 of plate 14. The specific mounting of vise jaw plates 12, 14 to the vise jaws 16, 18 forms an important aspect of the invention by ensuring the bottom sides 28 of the vise jaw plates are fully seated against the deck surface 52 of the vise, thereby preventing costly errors in the set-up of a work piece and providing reliable and repeatability in multiple unit production runs.

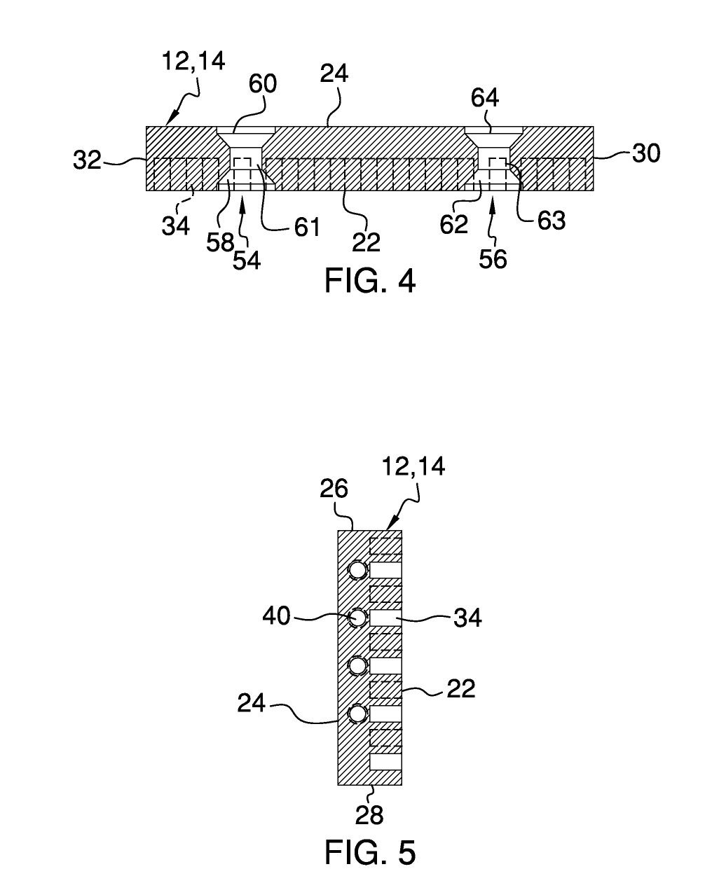

Turning to FIGS. 3 and 4, vise jaw plate 12, 14 includes first and second mounting through bores 54 and 56 spaced horizontally across the plate between the left and right ends 30 and 32 and extend through the front and back sides 22 and 24 thereof and in a direction normal to the front and back sides. Through bore 54 includes a frustoconical first bore portion 58 extending through the front side 22 and a frustoconical second bore portion 60 extending through the back side 24. Frustoconical bore portions 58 and 60 are connected together at their confronting narrow ends by straight bore portion 61.

Likewise, through bore 56 includes a frustoconical first bore portion 62 extending through the front side 22 and a frustoconical second bore portion 64 extending through the back side 24. Frustoconical bore portions 62 and 64 are connected together at their confronting narrow ends by a straight bore portion 63.

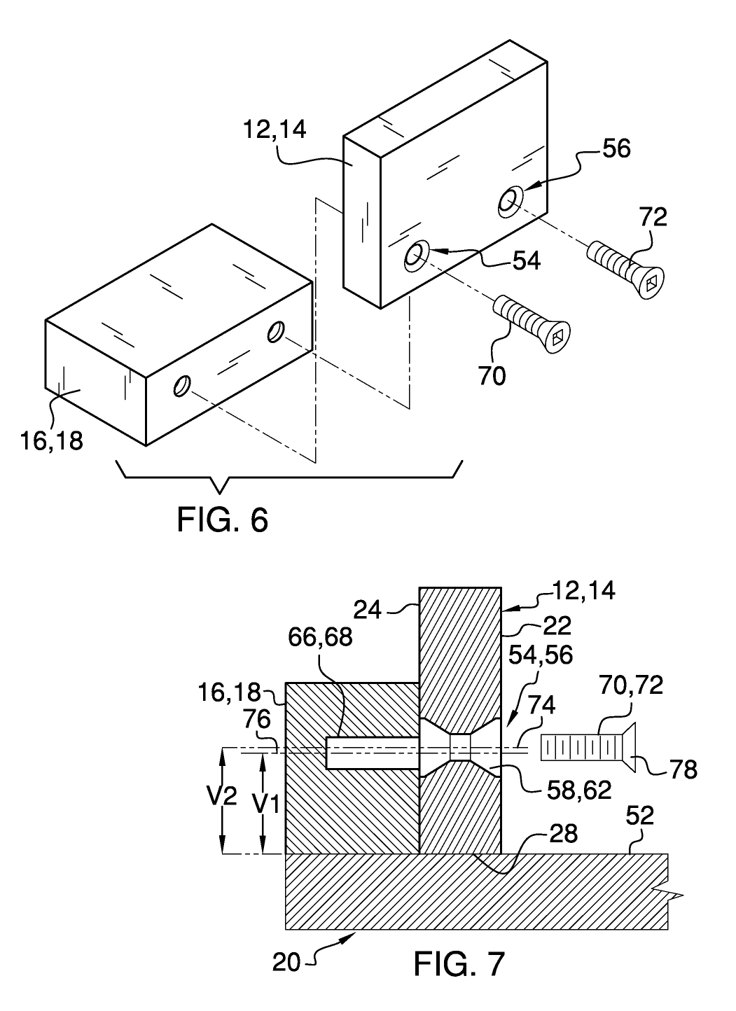

With reference to FIG. 6, vise jaw plate 12, 14 and vise jaw 16, 18 are diagrammatically illustrated in a simplified form for the purpose of illustrative clarity. Bores 54 and 56 of vise jaw plate 12, 14 are configured for cooperative alignment with threaded bores 66 and 68 of vise jaw 16, 18 for the reception of a threaded fastener 70 and 72, respectively, for the mounting of the vise jaw plate to the vise jaw.

Turning now to FIG. 7, there is illustrated an enlarged, diagrammatic cross-sectional view through vise jaws 16, 18 and vise jaw plates 12, 14. As shown here, the center-line 74 of bore 54, 56 is vertically offset a fractional distance from the center-line 76 of bore 66, 68. This offset distance is exaggerated for the purpose of illustrative clarity. The vertical offset of center-line 74 of bore 54, 56 relative to the center-line 76 of bore 66, 68 is best referenced relative to the deck surface 52 of the vise, wherein V1 is the elevation (vertical distance) of the center-line 76 of bore 66, 68 of the vise jaw from the deck surface 52 and V2 is the elevation (vertical distance) of the center-line 74 of bore 54, 56 of the vise jaw plate 12, 14 from the deck surface 52 as measured when the bottom surface 28 of the vise jaw plate is rested upon the deck surface. The V2 elevation of center-line 74 is greater than the V1 elevation of center line 76 or in other words, center-line 74 has a higher elevation from the deck surface 52 than center-line 76, with the difference in elevation equal to V2-V1. The elevation relation between center-line 74 and center-line 76 is a key aspect to the invention that ensures the bottom surface 28 of the vise jaw plate 12, 14 is fully seated against the deck surface 52 of the vise 20 when the vise jaw plate 12, 14 is mounted to the vise jaw 16, 18. Vise jaw plate 12, 14 is mounted to vise jaw 16, 18 by inserting fastener 70, 72 through bore 54, 56 and threading into bore 66, 68. As fastener 70, 72 is tightened, the head 78 thereof presses against the frustoconical bore portion 58, 62 (60, 64 if the vise jaw plate is oriented with the back side 24 facing outward) forcing the co-axial alignment of center-lines 74 and 76 and fully seating the bottom side 28 against the vice deck surface 52 by urging the vise jaw plate 12, 14 in a downwardly direction.

Additionally, while it is not specifically illustrated in the drawings of the figures, the action between the fasteners 70, 72 and bores 54, 56 as discussed above further operates to center the vise jaw plates 12, 14 horizontally (left-right across the vise jaw) with reliable repeatability, which is an additional advantage provided by the invention that is not found in the devices heretofore.

It is important to note, vise jaw plates 12 and 14 are configured for mounting to vise jaws 16 and 18 with the back sides 24 confronting as opposed to the front sides 22 confronting to provide smooth work piece griping surfaces if desired. In such a reverse mounting arrangement, the same function of seating the bottom sides 28 is provided.

A number of embodiments of the present invention have been described. Nevertheless, it will be understood that various modifications may be made without departing from the spirit and scope of the invention. Accordingly, other embodiments are within the scope of the following claims.

What is claimed is:

1. A vise jaw plate for mounting on a vise having a vise jaw with first and second jaw plate attachment holes elevated a first distance from a deck surface of the vise, the vise jaw plate comprising:
parallel front and back sides, left and right sides, and a bottom side being substantially flat and orthogonal to said front and back sides;
a plurality of equally sized holes arranged in a pattern and extending through said front side and terminating at a position intermediate said front and back sides; and
first and second mounting bores spaced horizontally between said left and right sides and extending through said front and said back sides and arranged for cooperative alignment a with the first and second vise jaw mounting holes, respectively, each of said first and second mounting bores having a first frustoconical portion extending through said front side, a second frustoconical portion extending through said back side, and a straight bore portion joining the confronting narrow ends of said first and second frustoconcial portions; and
each said first and second mounting bores elevated a second distance from the deck surface of the vise as measured when said bottom surface is rested upon the deck surface, said second distance of said first and second mounting bores being greater than the first distance of said first and second jaw plate attachment holes.

2. The vise jaw plate of claim 1, said pattern being a staggered column-row matrix with the centers of holes in a common row being spaced an equal distance D1 and with the centers of holes in a common column being spaced an equal distance D2.

3. The vise jaw plate of claim 2, wherein distance D1 is less than distance D2.

4. The vise jaw plate of claim 1, each of said holes is of a smooth bore and adapted to removably receive a dowel pin therein.

5. The vise jaw plate of claim 1, further comprising:
one or more threaded bores extending through at least one of said left and right sides.

6. An improved vise jaw plate assembly including first and second vise jaw plates for mounting on opposing first and second vise jaws, respectively, of a vise, each of the first and second vise jaws having first and second jaw plate attachment holes that are elevated a first distance from a deck surface of the vise, the improvement comprising each of said first and second vise jaw plates having:
parallel front and back sides and a bottom side being substantially flat and orthogonal to said front and back sides;
a plurality of equally sized holes arranged in a pattern and extending through said front side and terminating at a position intermediate said front and back sides; and
first and second mounting bores spaced horizontally between said left and right sides and extending through said front and said back sides and arranged for cooperative alignment a with the first and second vise jaw mounting holes, respectively, each of said first and second mounting bores having a first frustoconical portion extending through said front side, a second frustoconical portion extending through said back side, and a straight bore portion joining the confronting narrow ends of said first and second frustoconcial portions; and
each said first and second mounting bores elevated a second distance from the deck surface of the vise as measured when said bottom surface is rested upon the deck surface, said second distance of said first and second mounting bores being greater than the first distance of said first and second jaw plate attachment holes.

7. The vise jaw plate assembly of claim 6, wherein said pattern being a staggered column-row matrix with the centers of holes in a common row being spaced an equal distance D1 and with the centers of holes in a common column being spaced an equal distance D2.

8. The vise jaw plate assembly of claim 7, wherein distance D1 is less than distance D2.

9. The vise jaw plate assembly of claim 6, each of said holes is of a smooth bore and adapted to removably receive a dowel pin therein.

10. The vise jaw plate assembly of claim 6, wherein each of said first and second vise jaw plate further comprises:
one or more threaded bores extending through at least one of said left and right sides.

11. A vise jaw plate and vise assembly, comprising:
a vise having opposed first and second vise jaws, each of said first and second vise jaws having first and second jaw plate attachment holes that are elevated a first distance from a deck surface of the vise;
first and second vise jaw plates, each of said first and second vise jaw plates having parallel front and back sides and a bottom side being substantially flat and orthogonal to said front and back sides, a plurality of equally sized holes arranged in a pattern and extending through said front side and terminating at a position intermediate said front and back sides, first and second mounting bores spaced horizontally between said left and right sides and extending through said front and said back sides and arranged for cooperative alignment a with the first and second vise jaw mounting holes, respectively, each of said first and second mounting bores having a first frustoconical portion extending through said front side, a second frustoconical portion extending through said back side, and a straight bore portion joining the confronting narrow ends of said first and second frustoconcial portions, and each said first and second mounting bores elevated a second distance from the deck surface of the vise as measured when said bottom surface is rested upon the deck surface, said second distance of said first and second mounting bores being greater than the first distance of said first and second jaw plate attachment holes;
said first vise jaw plate mounted to said first vise jaw a threaded fastener extending through cooperatively aligned said first mounting bore and said first jaw plate attachment hole thereof and by a threaded fastener extending through cooperatively aligned said second mounting bore and said second jaw plate attachment hole, wherein said bottom surface of said first vise jaw being fully seated against said deck surface; and
said second vise jaw plate mounted to said second vise jaw a threaded fastener extending through cooperatively aligned said first mounting bore and said first jaw plate attachment hole thereof and by a threaded fastener extending through cooperatively aligned said second mounting bore and said second jaw plate attachment hole, wherein said bottom surface of said first vise jaw being fully seated against said deck surface.

12. The vise jaw plate and vise assembly of claim 11, wherein said pattern being a staggered column-row matrix with the centers of holes in a common row being spaced an equal distance D1 and with the centers of holes in a common column being spaced an equal distance D2.

13. The vise jaw plate and vise assembly of claim 12, wherein distance D1 is less than distance D2.

14. The vise jaw plate and vise assembly of claim 11, each of said holes is of a smooth bore and adapted to removably receive a dowel pin therein.

15. The vise jaw plate and vise assembly of claim 11, wherein each of said first and second vise jaw plate further comprises:
one or more threaded bores extending through at least one of said left and right sides.
